(19) United States
(12) Patent Application Publication
(10) Pub. No.: US 2012/0226476 A1
(43) Pub. Date: Sep. 6, 2012

(54) APPARATUS, SYSTEM, AND METHOD FOR CALCULATING DEFECT RATE

(75) Inventors: Ryusei Shingaki, Chiba (JP); Takeichiro Nishikawa, Kanagawa (JP); Minoru Nakatsugawa, Kanagawa (JP)

(73) Assignee: KABUSHIKI KAISHA TOSHIBA, Tokyo (JP)

(21) Appl. No.: 13/410,645

(22) Filed: Mar. 2, 2012

Related U.S. Application Data
(63) Continuation of application No. PCT/JP2009/066373, filed on Sep. 18, 2009.

(51) Int. Cl. G06F 15/00

(52) U.S. Cl. 702/181

(57) ABSTRACT

According to one embodiment, a first reading unit reads, from a defect database, first identification information corresponding to a first product type. A second reading unit reads, from a monitoring database, defect monitoring information corresponding to the first identification information and non-defect monitoring information that corresponds to the first product'type and that is other than the defect monitoring information. A generating unit generates a defect, model that models a probability of products becoming defective within a predetermined time period with respect to the monitoring information, based on the defect monitoring information and the non-defect monitoring information. A first calculating unit calculates a defect probability of products of a second product type by inputting the monitoring information corresponding to the second product type into the defect model. A second calculating unit calculates a defect rate of the products of the second product type based on the defect probability.

### CROSS-REFERENCE TO RELATED APPLICATIONS

This application is a Continuation Application of PCT international application No. PCT/JP2009/066373 filed on Sep. 18, 2009, which designates the United States; the entire contents of which are incorporated herein by reference.

### FIELD

Embodiments described herein relate to calculating a defect rate.

### BACKGROUND

As the life cycles of products are becoming shorter, there is an increasing need for quickly acquiring and analyzing failure information in the field and for providing relevant departments such as design, quality control, and service departments with feedback, to maintain the quality of the products. In the manufacturing industry, it is common practice to try to understand reliability of a product by analyzing product life, which can be calculated from the date on which a defective product started being used and the defect date. For example, it is possible to understand the reliability of the product by calculating a ratio (a defect rate) of the quantity of defective products to the quantity of operating products within a certain time period. JP-A 2007-328522 (KOKAI) proposes a technique by which a defect probability of devices is calculated with high precision by utilizing a defect record obtained after the devices start being operated.

When a sufficient time period has elapsed since shipping of products, it is easy to obtain a defect rate because almost all of the shipped products are in operation; however, not all the shipped products start operating immediately after being shipped. For this reason, a stable defect rate value is not calculated when the quantity of products in operation is extremely small immediately after the shipping. In other words, according to the method described in JP-A 2007-328522 (KOKAI) for example, it is difficult, in some situations, to acquire a defect rate that needs to be provided as feedback to the design department or the like.

### BRIEF DESCRIPTION OF THE DRAWINGS

FIG. 1 is a diagram of an overall configuration of a defect rate calculating system;

FIG. 2 is a drawing of an exemplary data structure of defect data;

FIG. 3 is a drawing of an exemplary data structure of monitoring data;

FIG. 4 is a functional block diagram of a defect rate calculating apparatus;

FIG. 5 is a flowchart of a defect model generating process;

FIG. 6 is a flowchart of a defect probability calculating process;

FIG. 7 is a flowchart of a defect rate calculating process;

FIG. 8 is a drawing of an example of output data; and

FIG. 9 is a flowchart of a probability density function estimating process.

### DETAILED DESCRIPTION

In general, according to one embodiment, a first reading unit reads, from a defect database, first identification information corresponding to a first product type. A second reading unit reads, from a monitoring database, defect monitoring information corresponding to the first identification information and non-defect monitoring information expressing monitoring information that corresponds to the first product type and that is other than the defect monitoring information. A generating unit generates a defect model that models a probability of products becoming defective within a predetermined time period with respect to the monitoring information, based on the defect monitoring information and the non-defect monitoring information. A first calculating unit calculates a defect probability of products of a second product type by inputting the monitoring information corresponding to the second product type into the defect model. A second calculating unit calculates a defect rate of the products of the second product type based on the calculated defect probability.

In the following sections, exemplary embodiments of a defect rate calculating apparatus, a defect rate calculate system, and a defect rate calculating method will be explained in detail, with reference to the accompanying drawings.

As explained above, it is difficult for the conventional method to calculate a defect rate with high precision when the quantity of products in operation is small because, for example, the products have just been shipped. In addition, to understand the quantity of products in operation, it is necessary to find out the date on which each of the non-defective products started being used. It is, however, possible to find out the date on which each of the non-defective products started being used, only for those products that are, for example, serviced by service engineers who visit their clients for maintenance purposes and check to see if the products are in operation. In other words, for other products that are sold through retail stores, for example, it is difficult to find out the date on which each of the products started being used.

Incidentally, for each apparatus, monitoring techniques have become popular by which it is possible to monitor the usage status and to sense malfunctions that may lead to defects. Such monitoring information (hereinafter, “monitoring data”) obtained as a result of the monitoring of the usage status is utilized for predicting an occurrence of a defect in each apparatus; however, the monitoring information is not utilized for understanding the quality of the products in the field as a whole.

Accordingly, by utilizing monitoring data obtained as a result of the monitoring of the usage status of each of the products, a defect rate calculating apparatus according to an embodiment described herein makes it possible to stably estimate the field quality (a defect rate) of the products connected to a network, even if the quantity of products in operation is small.

More specifically, at first, a defect model is generated from monitoring data and defect data of a type of a product (e.g., a past product type of which the warranty period has already expired) specified as a model generation target. Further, based on the generated defect model, a defect probability is calculated for another type of product (e.g., a new product type) specified as a defect rate analysis target, after monitoring data thereof has been collected. Further, by calculating a defect rate based on the quantity of products in operation obtained from the monitoring data of the analyzed products and the quantity of defective products obtained from the defect data, and further updating the defect rate with the calculated defect probability, it is possible to calculate a defect rate with high precision.

The “defect probability” denotes the probability of a product becoming defective within a predetermined time period (e.g., a warranty period). Further, the “defect rate” denotes the probability of a product becoming defective within a unit time period.

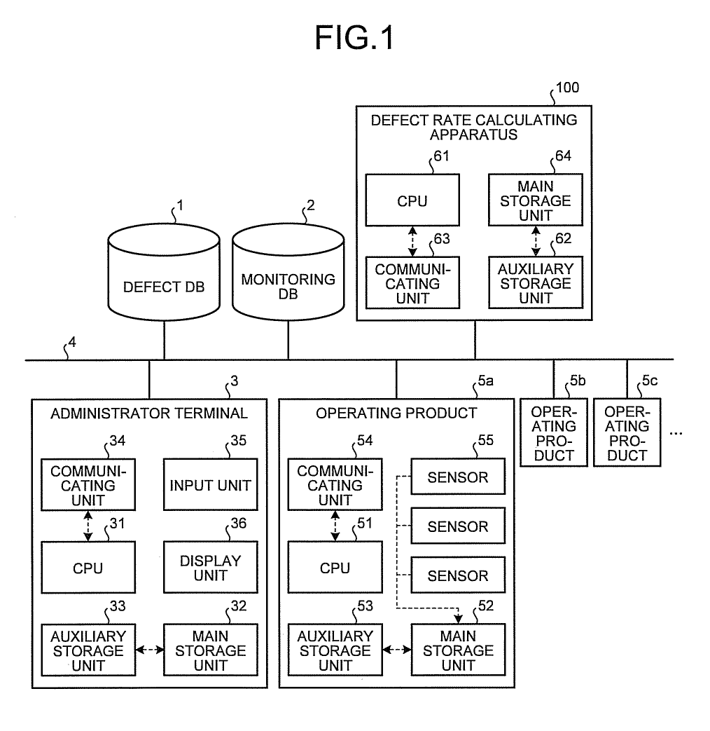

FIG. 1 is a diagram of an exemplary overall configuration of a defect rate calculating system according to the present embodiment. The defect rate calculating system according to the present embodiment includes a defect database (DB) 1, a monitoring database (DB) 2, an administrator terminal 3, operating products 5a to 5c, and a defect rate calculating apparatus 100. The administrator terminal 3, the operating products 5a to 5c (hereinafter, they may simply be referred to as “operating products 5”), and the defect rate calculating apparatus 100 are each configured with a processing apparatus such as a computer and are connected so as to be able to perform communication via a network 4, e.g., the Internet or a Local Area Network (LAN).

Although the three operating products 5 are shown in FIG. 1, the quantity of the operating products 5 is not limited to this example. Further, another configuration is acceptable in which the defect rate calculating apparatus 100 includes the defect DB 1 and the monitoring DB 2. Alternatively, it is acceptable for one or more other servers (not shown) to include the defect DB 1 and the monitoring DB 2.

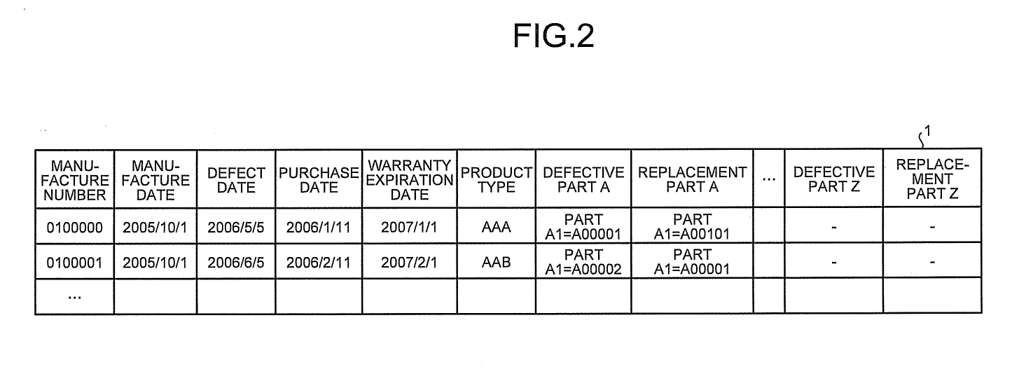

The defect DB 1 stores therein defect data that is information of one or more defective products. FIG. 2 is a drawing of an exemplary data structure of the defect data stored in the defect DB 1. As shown in FIG. 2, the defect DB 1 stores therein the defect data in which the following pieces of information are kept in correspondence with one another: a manufacture number; a manufacture date; a defect date; a purchase date; a warranty expiration date; a product type; defective component parts (hereinafter, “defective parts”) A to Z; and replacement component parts (hereinafter, “replacement parts”) A to Z.

The manufacture number is identification information that identifies each of the products. The product type is information that identifies a type of the products (a manufacture model). For example, the name of the type of the product (the name of the manufacture model) can be specified as the product type. It is also possible that a plurality of pieces of information are specified as the defective parts and the replacement parts, depending on the configuration of each of the products. Another arrangement is also acceptable in which the manufacture date of each of the products corresponding to a manufacture number can be obtained by referring to another storage unit (not shown) or the like, instead of the defect DB 1. Accordingly, it is possible to identify one or more products that were manufactured during a model generation target manufacture period (described later) being input.

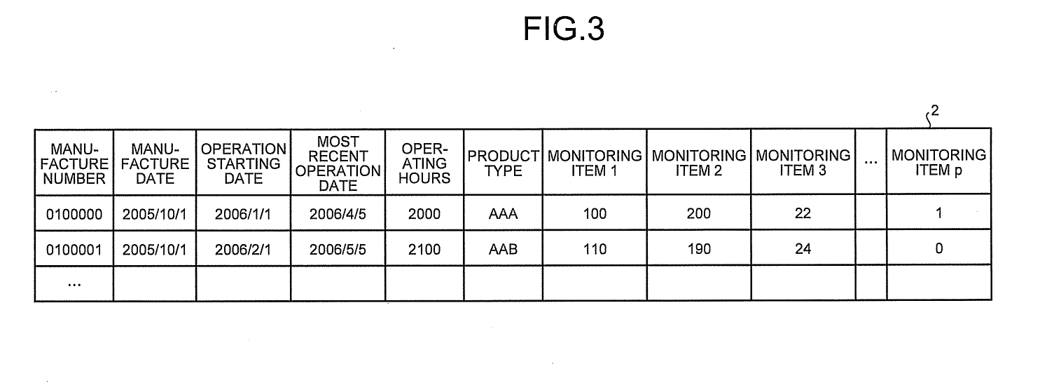

Returning to the description of FIG. 1, the monitoring DB 2 stores therein monitoring data indicating a usage status of each of the products. FIG. 3 is a drawing of an exemplary data structure of the data stored in the monitoring DB 2. As shown in FIG. 3, the monitoring DB 2 stores therein the following pieces of information that are kept in correspondence with one another: a manufacture number; a manufacture date; an operation starting date; a most recent operation date; operating hours; a product type; and a plurality of monitoring items 1 to p.

The monitoring items 1 to p denote predetermined items that indicate the usage status of each of the operating products 5. Each of the monitoring items corresponds to a different one of the items measured by sensors 55 (explained later) included in each of the operating products 5. In the following sections, measured values actually measured by the sensors 55 and the like corresponding to the monitoring items will be referred to as “monitoring data”.

It is possible to configure the defect DB 1 and the monitoring DB 2 each by using any commonly-used storage medium such as a Hard Disk Drive (HDD), an optical disk, a memory card, a Random Access Memory (RAM), or the like.

Returning to the description of FIG. 1, the administrator terminal 3 is a terminal device used by a quality control person and includes a Central Processing Unit (CPU) 31, a main storage unit 32, an auxiliary storage unit 33, a communicating unit 34, an input unit 35, and a display unit 36.

The CPU 31 is a controlling device that controls overall processing of the administrator terminal 3. The main storage unit 32 is, for example, a storage device configured so as to temporarily store various types of information therein and is configured by using a Random Access Memory (RAM) or the like. The auxiliary storage unit 33 is, for example, a storage device that stores therein various types of computer programs executed by the CPU 31 and is configured by using a Hard Disk Drive (HDD), a Compact Disc (CD) drive device, or the like.

The communicating unit 34 is configured to communicate with other apparatuses via the network 4. The input unit 35 is configured by using a keyboard, a mouse, and/or the like. The display unit 36 is configured by using a display device or the like that is able to display information such as a processing result.

When input information (e.g., a model generation target type, a model generation target manufacture period, an analysis date, and an analysis target type) is input via the input unit 35 by the quality control person, the CPU 31 transmits the input information via the communicating unit 34 to the defect rate calculating apparatus 100 connected to the network 4. Further, the communicating unit 34 included in the administrator terminal 3 receives information transmitted from the defect rate calculating apparatus 100 as a result of processing performed by the defect rate calculating apparatus 100 according to the input information. The display unit 36 displays the received information under the control of the CPU 31.

Each of the operating products 5 includes a CPU 51, a main storage unit 52, an auxiliary storage unit 53, a communicating unit 54, and the plurality of sensors 55. The CPU 51, the main storage unit 52, the auxiliary storage unit 53, and the communicating unit 54 have the same functions as those of the CPU 31, the main storage unit 32, the auxiliary storage unit 33, and the communicating unit 34 included in the administrator terminal 3, respectively.

Each of the operating products 5 is connected so as to be able to communicate with the monitoring DB 2 via the network 4.

Each of the sensors 55 measures monitoring data of a different one of the monitoring items indicating the usage status of the operating product 5 and outputs the monitoring data represented by a measured value. Each of the sensors 55 corresponds to, for example, a temperature sensor that measures the temperature of different parts of the operating product 5, an acceleration sensor that measures an acceleration of the operating product 5, a Self-Monitoring Analysis and Reporting Technology (S. M. A. R. T.) system provided for the HDD, a Basic Input/Output System (BIOS) that obtains a start-up log, or the like. Examples of the sensors 55 are not limited to those listed above. Any other sensors are applicable as long as it is possible to measure therewith the predetermined information (the monitoring data) indicating the usage status of the operating product 5.

Via the communicating unit 54 and under the control of the CPU 51, the pieces of monitoring data obtained by the sensors 55 included in each of the operating products 5 are transmitted, at predetermined times, to the defect rate calculating apparatus 100 connected to the network 4.

The defect rate calculating apparatus 100 includes a CPU 61, an auxiliary storage unit 62, a communicating unit 63, and a main storage unit 64. The CPU 61, the main storage unit 64, the auxiliary storage unit 62, and the communicating unit 63 have the same functions as those of the CPU 31, the main storage unit 32, the auxiliary storage unit 33, and the communicating unit 34 included in the administrator terminal 3, respectively.

The defect rate calculating apparatus 100 manages what is stored in the monitoring DB 2 connected via the network 4. For example, when the communicating unit 63 has received the pieces of monitoring data transmitted from each of the operating products 5, the CPU 61 registers the received pieces of monitoring data into the monitoring DB 2 by using the format shown in FIG. 3, for example.

Further, when the communicating unit 63 has received the input information input through the administrator terminal 3, the CPU 61 reads the various types of computer programs stored in the auxiliary storage unit 62 into the main storage unit 64. After that, the CPU 61 extracts the defect data and the monitoring data from the defect DB 1 and the monitoring DB 2 according to the input information and transmits processed and statistical-worked results to the administrator terminal 3 connected via the network 4, by using the communicating unit 63. The input information, as well as a data extracting process, the processing, and the statistical working performed according to the input information will be explained in detail later.

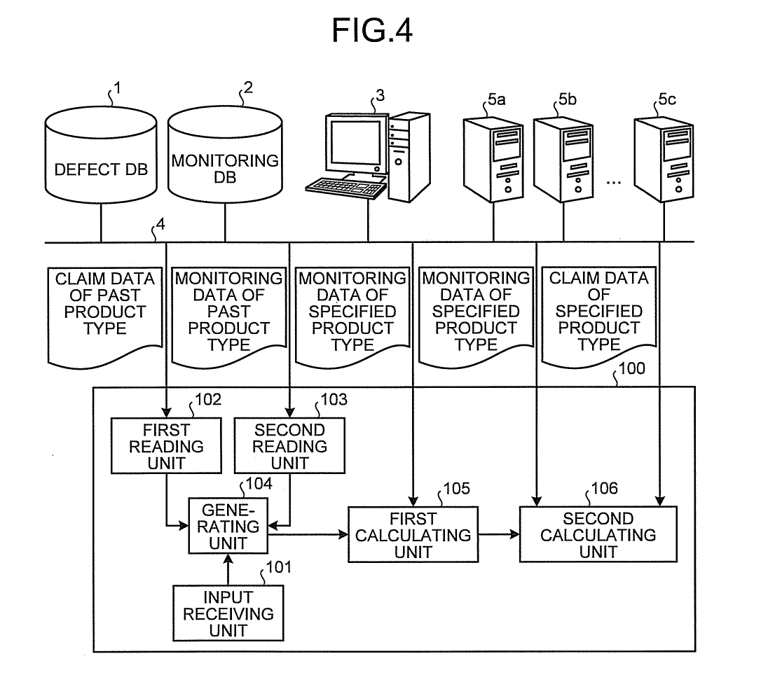

FIG. 4 is a functional block diagram of an exemplary functional configuration of the defect rate calculating apparatus 100. In FIG. 4, examples of the information exchanged among the administrator terminal 3, the defect rate calculating apparatus 100, the defect DB 1, the monitoring DB 2 are also shown.

As shown in FIG. 4, the defect rate calculating apparatus 100 includes, as a primary functional configuration thereof, an input receiving unit 101, a first reading unit 102, a second reading unit 103, a generating unit 104, a first calculating unit 105, and a second calculating unit 106.

The input receiving unit 101 receives an input of various types of information required in the calculation of a defect rate. For example, the input receiving unit 101 receives the input information input from the administrator terminal 3. The input information includes, for example, a model generation target type, a model generation target manufacture period, a window size, an analysis target type, a prior defect probability, and an analysis date.

The model generation target type denotes a product type (a first product type) of the products of which the monitoring data from which the generating unit 104 generates a defect model is to be obtained. The model generation target manufacture period denotes the manufacture period of the products of which the monitoring data from which the generating unit 104 generates the defect model is to be obtained. The window size denotes a smoothing parameter (a band width) used by the generating unit 104 to perform a kernel density estimation. The analysis target type denotes a product type (a second product type) of the products of which the first calculating unit 105 and the second calculating unit 106 calculate the defect rate. The prior defect probability is a defect probability referred to by the first calculating unit 105 when calculating a defect probability (a posterior defect probability) for each of the products by performing a Bayesian estimation. For example, an arrangement is acceptable in which an average defect probability of all the product types is input as the prior defect probability. In principle, the analysis date is the date on which the quality control person performs an analysis; however, it is also possible to specify a past date as the analysis date.

The input receiving unit 101 outputs the received information to any of the components that uses the information, such as the generating unit 104, the first calculating unit 105, and the second calculating unit 106.

The first reading unit 102 reads, from the defect DB 1, one or more manufacture numbers that correspond to the model generation target type received by the input receiving unit 101 and of which the corresponding manufacture dates are included in the model generation target manufacture period. As explained above, a past product type, for example, is specified as the model generation target type. FIG. 4 indicates that one or more manufacture numbers represented by claim data of a past product type are read from the defect DB 1.

The second reading unit 103 reads, from the monitoring DB 2, pieces of monitoring data that correspond to the model generation target type and of which the corresponding manufacture dates are included in the model generation target manufacture period, while dividing the pieces of monitoring data into those of defective products and those of non-defective products. More specifically, the second reading unit 103 first reads monitoring data (hereinafter, “defect monitoring data”) corresponding to the manufacture numbers read by the first reading unit 102. Further, the second reading unit 103 reads monitoring data (hereinafter, “non-defect monitoring data”) corresponding to the manufacture numbers other than the manufacture numbers read by the first reading unit 102, from among the monitoring data that corresponds to the model generation target type and of which the manufacture dates are included in the model generation target manufacture period.

By using the defect monitoring data and the non-defect monitoring data, the generating unit 104 generates a defect model used for calculating a defect probability while the monitoring data is given. The defect model generating process will be explained in detail later.

The first calculating unit 105 calculates a defect probability of each of the products corresponding to the analysis target type, based on the generated defect model. The defect probability calculating process performed by the first calculating unit 105 will be explained in detail later.

The second calculating unit 106 calculates a defect rate of the products, as a whole, corresponding to the analysis target type, by using a predetermined algorithm, based on the defect probability calculated for each of the products corresponding to the analysis target type, the quantity (an operating quantity) of operating products corresponding to the analysis target type, and the quantity (a defect quantity) of products that became defective during the warranty period among the products corresponding to the analysis target type. It is possible to judge whether a warranty period has expired or not, by referring to the warranty expiration date included in the defect data. The defect rate calculating process performed by the second calculating unit 106 will be explained in detail later.

It is possible to realize the functional units such as the input receiving unit 101, the first reading unit 102, the second reading unit 103, the generating unit 104, the first calculating unit 105, and the second calculating unit 106, as a computer program executed by the CPU 61, for example. In that situation, when a module-structured computer program that is stored in the auxiliary storage unit 62 and includes these functional units is read into the main storage unit 64 and executed by the CPU 61, these functional units are loaded into the main storage unit 64, so that these functional units are generated in the main storage unit 64.

Next, the defect model generating process performed by the defect rate calculating apparatus 100 according to the present embodiment configured as described above will be explained, with reference to FIG. 5. FIG. 5 is a flowchart of an overall flow in the defect model generating process according to the present embodiment.

First, the input receiving unit 101 receives an input of a model generation target type and a model generation target manufacture period specified by a quality control person (step S501). After that, the first reading unit 102 reads, from the defect DB 1, one or more manufacture numbers that correspond to the model generation target type received by the input receiving unit 101 and of which the manufacture dates are included in the model generation target manufacture period (step S502). Subsequently, the second reading unit 103 reads, from the monitoring DB 2, monitoring data corresponding to the manufacture numbers matching the read manufacture numbers, as defect monitoring data (step S503). Also, the second reading unit 103 reads, from the monitoring DB 2, monitoring data that corresponds to the model generation target type and to the manufacture numbers not matching the read manufacture numbers and of which the manufacture dates are included in the model generation target manufacture period, as non-defect monitoring data (step S504).

After that, the generating unit 104 estimates probability density functions of each of the monitoring items by performing a kernel density estimation, based on the defect monitoring data and the non-defect monitoring data (step S505). More specifically, the generating unit 104 estimates the probability density function (a first density function) of each of the monitoring items, based on the defect monitoring data, by using Expression (1) shown below. Further, the generating unit 104 estimates the probability density function (a second density function) of each of the monitoring items, based on the non-defect monitoring data, by using Expression (2) shown below.

$$\begin{matrix}{\hat{f}}_{k}^{( 1 )} ( {x}_{k} ) = \frac{1}{{N}^{( 1 )} λ} {\sum }_{i = 1}^{{N}^{( 1 )}} {K}_{λ} ( {x}_{k} , {x}_{ik}^{( 1 )} ) & ( 1 ) \\ {\hat{f}}_{k}^{( 0 )} ( {x}_{k} ) = \frac{1}{{N}^{( 0 )} λ} {\sum }_{i = 1}^{{N}^{( 0 )}} {K}_{λ} ( {x}_{k} , {x}_{ik}^{( 0 )} ) & ( 2 )\end{matrix}$$

In the expressions above, xᵢₖ⁽¹⁾ denotes a value (monitoring data) for a monitoring item k of a defective product i, whereas xᵢₖ⁽⁰⁾ denotes a value (monitoring data) for the monitoring item k of a non-defective product i. N⁽¹⁾ denotes a defect quantity, whereas N⁽⁰⁾ denotes a non-defect quantity. Further, K_{λ}(xₖ, xᵢₖ⁽¹⁾) denotes a Gaussian kernel defined by Expression (3) shown below. Also, K_{λ}(xₖ, xᵢₖ⁽⁰⁾) used in Expression (2) is defined in the same manner.

$${K}_{λ} ( {x}_{k} , {x}_{ik}^{( 1 )} ) = \frac{1}{\sqrt{2 π} λ} exp ( - \frac{1}{2 {λ}^{2}} {( {x}_{k} - {x}_{ik}^{( 1 )} )}^{2} ) \qquad ( 3 )$$

In these expressions, λ denotes the window size obtained by the input receiving unit 101 and may satisfy, for example, λ=0.2. As for any of the monitoring items that can have a discrete value, the product ratio for each of the possible discrete values may be used as an estimated value of a probability function. For example, when the value of the monitoring item k can be any of the values a₁ to a_{J} of which the total quantity is equal to J, the probability density function may be estimated as shown in Expression (4) below. In Expression (4), j is an integer that satisfies 1≦j≦J.

$${\hat{f}}_{k}^{( 1 )} ( {x}_{k} = {a}_{j} ) = \frac{1}{{N}^{( 1 )}} {\sum }_{i = 1}^{{N}^{( 1 )}} I ( {x}_{ik}^{( 1 )} = {a}_{j} ) \qquad ( 4 )$$

where

$${\sum }_{i = 1}^{{N}^{( 1 )}} I ( {x}_{ik}^{( 1 )} = {a}_{j} )$$

denotes the quantity of products of which the value xᵢₖ⁽¹⁾ for the monitoring item k is equal to aj.

Subsequently, the generating unit 104 estimates a joint density function (a first joint density function) related to all the monitoring items of the defective products by using Expression (5) shown below. Also, the generating unit 104 estimates a joint density function (a second joint density function) related to all the monitoring items of the non-defective products by using Expression (6) shown below (step S506). In these expressions, p denotes the number of monitoring items.

$$\begin{matrix}{\hat{f}}^{( 1 )} ( {x}_{1} , {x}_{2} , … , {x}_{p} ) = {\prod }_{k = 1}^{p} {\hat{f}}_{k}^{( 1 )} ( {x}_{k} ) & ( 5 ) \\ {\hat{f}}^{( 0 )} ( {x}_{1} , {x}_{2} , … , {x}_{p} ) = {\prod }_{k = 1}^{p} {\hat{f}}_{k}^{( 0 )} ( {x}_{k} ) & ( 6 )\end{matrix}$$

The joint density functions calculated in this manner correspond to a defect model used for calculating a defect probability while certain monitoring data is given.

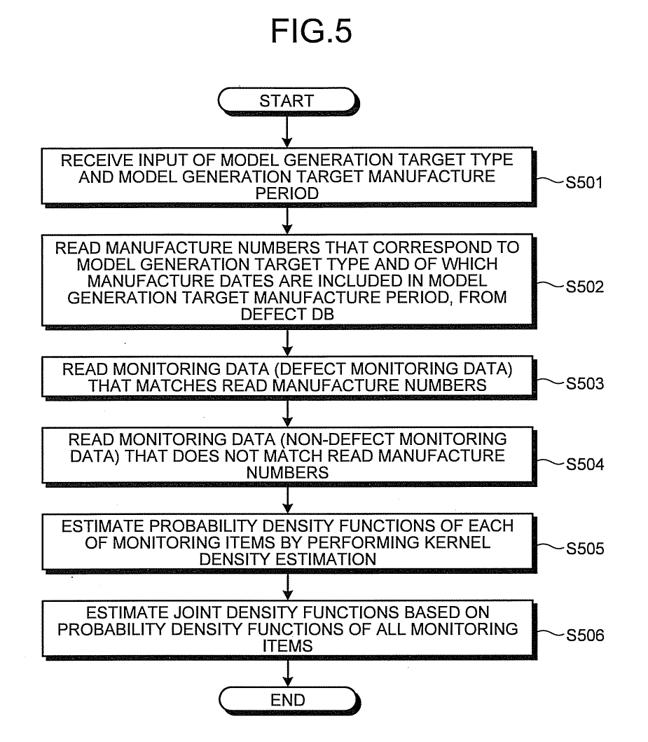

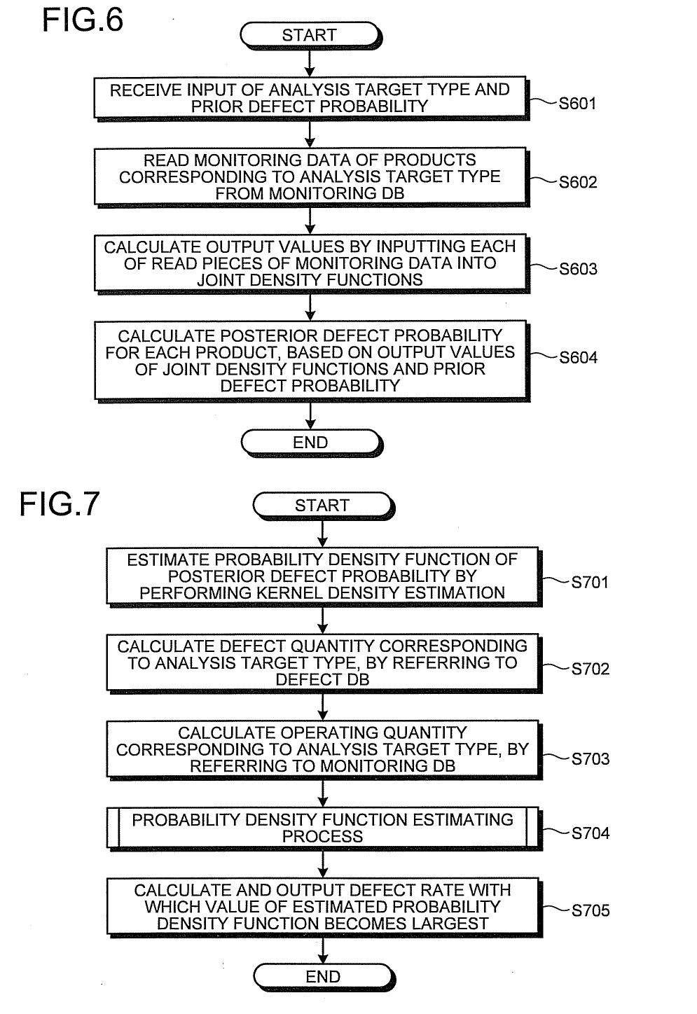

Next, the defect probability calculating process performed by the first calculating unit 105 will be explained, with reference to FIG. 6. FIG. 6 is a flowchart of an overall flow in the defect probability calculating process according to the present embodiment.

First, the input receiving unit 101 receives an input of an analysis target type specified by the quality control person and a prior defect probability (step S601). Subsequently, the first calculating unit 105 reads, from the monitoring DB 2, monitoring data (hereinafter, “analysis target monitoring data”) corresponding to the input analysis target type (step S602).

After that, by using Expression (7) shown below, the first calculating unit 105 calculates a joint density function value (a first output value) of the defective products based on the analysis target monitoring data, by using the joint density function of the defective products estimated by the generating unit 104. Also, by using Expression (8) shown below, the first calculating unit 105 calculates a joint density function value (a second output value) of the non-defective products (step S603). In these expressions, zᵢ₁ zᵢ₂, . . . , zᵢₚ denote the values (monitoring data) for the monitoring items 1, 2, . . . , p, respectively, of a product i corresponding to the analysis target type.

\hat{f}⁽¹⁾(zᵢ₁,zᵢ₂, . . . , zᵢₚ) (7)

\hat{f}⁽⁰⁾(zᵢ₁,zᵢ₂, . . . , zᵢₚ) (8)

Subsequently, by using Expression (9) shown below, the first calculating unit 105 calculates a value of a posterior defect probability of each of the products, based on the calculated joint density function of each of the products corresponding to the analysis target type and the prior defect probability value obtained by the input receiving unit 101 (step S604).

$${μ}_{i} = \frac{{π}_{1} {\hat{f}}^{( 1 )} ( {z}_{i 1} , {z}_{i 2} , … , {z}_{ip} )}{{π}_{1} {\hat{f}}^{( 1 )} ( {z}_{i 1} , {z}_{i 2} , … , {z}_{ip} ) + ( 1 - {π}_{1} ) {\hat{f}}^{( 0 )} ( {z}_{i 1} , {z}_{i 2} , … , {z}_{ip} )} \qquad ( 9 )$$

In this expression, π₁ denotes the prior defect probability obtained by the input receiving unit 101. As mentioned above, an average defect probability of all the product types may be used as π₁.

In the description above, the value of the posterior defect probability is estimated by using Expression (9), via the joint density functions shown in Expressions (7) and (8). However, the method for estimating the posterior defect probability is not limited to this example. For example, it is also acceptable to calculate a value of the posterior defect probability of each of the products by using a non-linear model such as a neural network, as shown in Expression (10) below.

$${μ}_{1} = σ ( {\sum }_{j = 1}^{M} {w}_{kj}^{( 2 )} h ( {\sum }_{i = 1}^{p} {w}_{ji}^{( 1 )} {z}_{i} + {w}_{j 0}^{( 1 )} ) + {w}_{k 0}^{( 2 )} ) \qquad ( 10 )$$

In this expression, σ(x) and h(x) are each a logistic sigmoid function expressed by Expressions (11) and (12) shown below.

$$\begin{matrix}σ ( x ) = \frac{1}{1 + exp ( - x )} & ( 11 ) \\ h ( x ) = \frac{1}{1 + exp ( - x )} & ( 12 )\end{matrix}$$

Alternatively, it is also acceptable to use a linear function h(x)=x for h(x). In the expression above, wₖⱼ⁽²⁾ and wⱼᵢ⁽¹⁾ are network parameters obtained by using a backpropagation, based on the defect monitoring data and the non-defect monitoring data. In this situation, the non-linear model learned by using the monitoring data (i.e., the defect monitoring data and the non-defect monitoring data) of the model generation target type corresponds to the defect model.

Next, the defect rate calculating process performed by the second calculating unit 106 will be explained, with reference to FIG. 7. FIG. 7 is a flowchart of an overall flow in the defect rate calculating process according to the present embodiment.

First, by using Expression (13) shown below, the second calculating unit 106 estimates a probability density function of the posterior defect probability of the products corresponding to the analysis target type calculated by the first calculating unit 105 (step S701).

$$\hat{f} ( μ ) = \frac{1}{N λ} {\sum }_{i = 1}^{N} {K}_{λ} ( μ , {μ}_{i} ) \qquad ( 13 )$$

In this expression, μᵢ denotes a posterior defect probability of a product i corresponding to the analysis target type, whereas N denotes the quantity (the operating quantity) of the products corresponding to the analysis target type. Further, K_{λ}(μ,μᵢ) denotes a Gaussian kernel defined in the same manner as in Expression (3) above.

Subsequently, the second calculating unit 106 calculates the quantity of pieces of data in the defect DB 1 of which the product type matches the analysis target type and of which the warranty expiration date has not expired, as the defect quantity of the analysis target type (step S702). Further, the second calculating unit 106 calculates the quantity of pieces of data in the monitoring DB 2 of which the product type matches the analysis target type, as the operating quantity of the analysis target type (step S703).

After that, the second calculating unit 106 performs a probability density function estimating process to estimate a probability density function of the posterior defect rate of the analysis target type, by using a Metropolis-Hastings algorithm, based on the defect quantity, the operating quantity, and the probability density functions of the posterior defect probability for the analysis target type (step S704). The probability density function estimating process will be explained in detail later.

Subsequently, the second calculating unit 106 calculates a value of the posterior defect rate with which the value of the probability density function estimated in the probability density function estimating process becomes the largest, as well as a 5% percentile point and a 95% percentile point and transmits the calculation results to the administrator terminal 3 by using the communicating unit 63 (step S705).

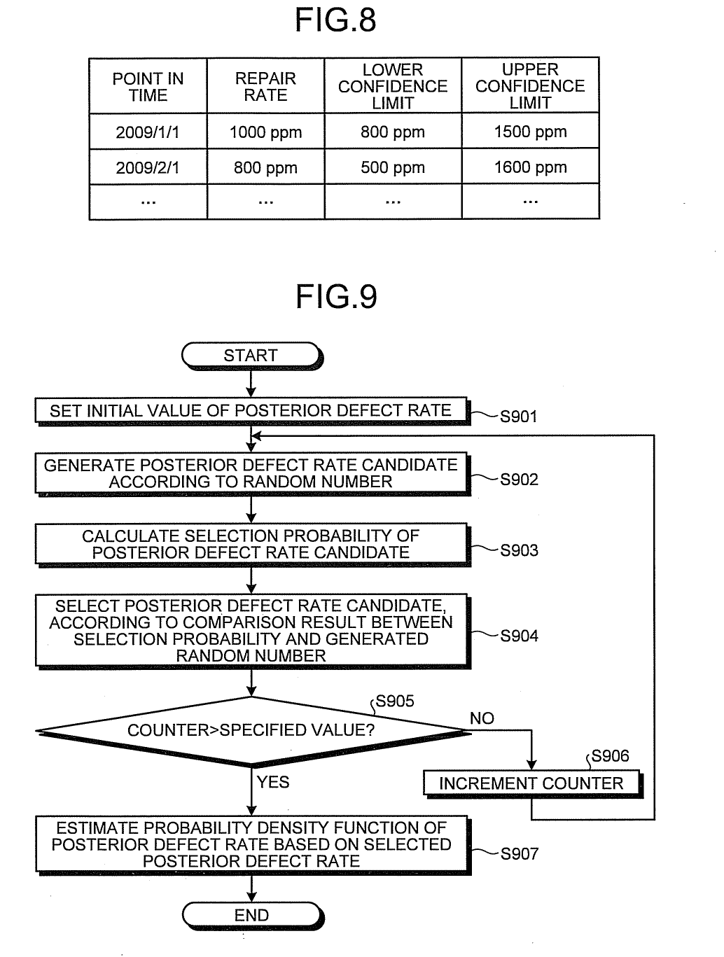

FIG. 8 is a drawing of an example of the output data. In FIG. 8, an example is shown in which a point in time expressing the analysis date, a repair rate expressing the posterior defect rate in Parts Per Million (PPM) units, a lower confidence limit corresponding to the 5% percentile point, and an upper confidence limit corresponding to the 95% percentile point are output. When having received such data, the administrator terminal 3, for example, generates a chart showing posterior defect rates at different points in time and displays the generated chart on the display unit 36.

Next, the probability density function estimating process at step S704 will be explained in detail, with reference to FIG. 9. FIG. 9 is a flowchart of an overall flow in the probability density function estimating process according to the present embodiment.

First, the second calculating unit 106 calculates an initial value μ⁽⁰⁾ of the posterior defect rate by calculating μ⁽⁰⁾=r/N (step S901). In the expression, r denotes the defect quantity corresponding to the analysis target type, whereas N denotes the operating quantity corresponding to the analysis target type. Further, the second calculating unit 106 initializes a loop counter t to 1.

Subsequently, while the loop counter is set to t−1, the second calculating unit 106 generates a posterior defect rate candidate μ′ according to a random number, based on a normal distribution expressed by Expression (14) shown below (step S902).

$$q ( {μ}^{( t - 1 )} , {μ}^{′} \vert r ) = \frac{1}{\sqrt{2 π r ( N - r ) / N}} exp ( - \frac{N}{2 r ( N - r )} {( {μ}^{′} - \frac{r}{N} )}^{2} ) \qquad ( 14 )$$

After that, while the loop counter is set to t−1, the second calculating unit 106 calculates a selection probability of the posterior defect rate candidate μ′, by using Expression (15) shown below (step S903).

$$α ( {μ}^{( t - 1 )} , {μ}^{′} \vert r ) = min \{ 1 , \frac{\hat{f} ( {μ}^{′} ) {( {μ}^{′} )}^{r} {( 1 - {μ}^{′} )}^{N - r}}{\hat{f} ( {μ}^{( t - 1 )} ) {( {μ}^{( t - 1 )} )}^{r} {( 1 - {μ}^{( t - 1 )} )}^{N - r}} exp ( - \frac{N}{2 r ( N - r )} ( {( {μ}^{( t - 1 )} - \frac{r}{N} )}^{2} + {( {μ}^{′} - \frac{r}{N} )}^{2} ) ) \} \qquad ( 15 )$$

where \hat{f}(μ) is a probability density function of the posterior defect probability of the products corresponding to the analysis target type.

After that, while the loop counter is set to t−1, the second calculating unit 106 generates a uniform random number u that runs between 0 and 1 and, as shown in Expression (16) below, the second calculating unit 106 selects a posterior defect rate candidate μ^{(t)} while the loop counter is set to t, according to a comparison result between the selection probability and the generated random number, so as to generate the selected candidate as a sample of the posterior defect rate (step S904).

$${μ}^{( t )} = \{ \begin{matrix}{μ}^{′} , & if u \leq α ( {μ}^{( t - 1 )} , {μ}^{′} \vert r ) \\ {μ}^{( t - 1 )} , & if u > α ( {μ}^{( t - 1 )} , {μ}^{′} \vert r )\end{matrix} \qquad ( 16 )$$

where α(μ^{(t-1)}, μ′|r) is the selection probability of the posterior defect rate candidate μ′.

Subsequently, the second calculating unit 106 compares the loop counter with a specified value T specified as an upper limit of the loop counter (step S905). As for the specified value T, for example, a value specified by the quality control person is arranged to be received by the input receiving unit 101. If the loop counter is not larger than the specified value T (step S905: No), the second calculating unit 106 increments the loop counter by 1 (step S906) and repeats the process (step S902).

On the contrary, if the loop counter is larger than the specified value T (step S905: Yes), the second calculating unit 106 estimates the probability density function of the posterior defect rate based on the generated sample of the posterior defect rate corresponding to the analysis target tape, by using Expression (17) shown below (step S907).

$$\hat{g} ( μ ) = \frac{1}{T λ} {\sum }_{t = 1}^{T} {K}_{λ} ( μ , {μ}^{( t )} ) \qquad ( 17 )$$

In the expression, μ^{(t)} denotes the posterior defect rate generated as a sample while the counter is set to t. T denotes the specified value that is specified as the upper limit of the loop counter. K_{λ}(μ, μ^{(t)}) denotes a Gaussian kernel defined in the same manner as in Expression (3) above.

As explained above, in the defect rate calculating system according to the present embodiment, because the defect rate estimated from the monitoring data is used, it is possible to calculate a repair rate with a stable precision level, even if the quantity of defective products is small. Thus, it is possible to find out quality issues at an earlier stage and to promptly provide feedback for the design department or the like. Further, because the impact of the performance of the operating products on the repair rate (the defect rate) is taken into consideration, it is possible to calculate a repair rate (a defect rate) that reflects a degradation of the product quality, even in a situation where the performance of the operating products as a whole rapidly deteriorates.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A defect rate calculating apparatus comprising:
a first reading unit that reads, from a defect database storing therein product types of defective products and pieces of identification information of the defective products that are kept in correspondence with one another, first identification information that is one of the pieces of identification information corresponding to a first product type being specified;
a second reading unit that reads, from a monitoring information database storing therein monitoring information indicating usage statuses of products, the product types, and the pieces of identification information that are kept in correspondence with one another, defect monitoring information and non-defect monitoring information, defect monitoring information being the monitoring information corresponding to the first identification information, non-defect monitoring information being the monitoring information that corresponds to the first product type and that is other than the defect monitoring information;
a generating unit that generates a defect model that models a probability of the products becoming defective within a predetermined time period with respect to the monitoring information, based on the defect monitoring information and the non-defect monitoring information;
a first calculating unit that reads, from the monitoring information database, a pieces of the monitoring information corresponding to a second product type being specified and calculates a defect probability expressing a probability of products of the second product type becoming defective within the predetermined time period, based on an output value obtained by inputting the pieces of monitoring information into the defect model; and
a second calculating unit that calculates a defect rate expressing a probability of the products of the second product type becoming defective within a unit time period, based on an operating quantity of the products of the second product type, a defect quantity expressing a quantity of products that have become defective among the products of the second product type, and the defect probability.

2. The defect rate calculating apparatus according to claim 1, wherein
the monitoring information database stores therein a plurality of pieces of monitoring information in correspondence with the product types and the identification information, and
the generating unit calculates a plurality of first density functions expressing probability density functions of a plurality of pieces of defect monitoring information, respectively, further calculates a plurality of second density functions expressing probability density functions of a plurality of pieces of non-defect monitoring information, respectively, and generates the defect model including a first joint density function that is a mathematical product of the plurality of first density functions and a second joint density function that is a mathematical product of the plurality of second density functions.

3. The defect rate calculating apparatus according to claim 2, wherein the first calculating unit reads, from the monitoring information database, the pieces of the monitoring information corresponding to the second product type being specified, calculates a first output value and a second output value by inputting the pieces of monitoring information into the first joint density function and the second joint density function, respectively, that are included in the defect model, and calculates the defect probability that is a posterior defect probability based on a Bayes' theorem, from a prior defect probability being specified, while using the first output value and the second output value as likelihood values.

4. The defect rate calculating apparatus according to claim 1, wherein the generating unit generates the defect model obtained by learning from a neural network while using the defect monitoring information and the non-defect monitoring information.

5. The defect rate calculating apparatus according to claim 1, wherein, while using a value obtained by dividing the defect quantity by the operating quantity as an initial value of the defect rate, the second calculating unit selects a sample of the defect rate according to a selection probability calculated from the defect probability by using a Metropolis-Hastings algorithm and further calculates a probability density function of the defect rate based on the sample.

6. A defect rate calculating system including a terminal apparatus and a defect rate calculating apparatus connected to the terminal apparatus via a network, wherein the terminal apparatus comprises: a first communicating unit that transmits a first product type and a second product type specified from among product types of products, to the defect rate calculating apparatus, and
the defect rate calculating apparatus comprises:
a second communicating unit that receives the first product type and the second product type from the terminal apparatus;
a first reading unit that reads, from a defect database storing therein product types of defective products and pieces of identification information of the defective products that are kept in correspondence with one another, first identification information that is one of the pieces of identification information corresponding to the received first product type;
a second reading unit that reads, from a monitoring information database storing therein monitoring information indicating usage statuses of products, the product types, and the pieces of identification information that are kept in correspondence with one another, defect monitoring information and non-defect monitoring information, defect monitoring information being the monitoring information corresponding to the first identification information, non-defect monitoring information being the monitoring information that corresponds to the first product type and that is other than the defect monitoring information;
a generating unit that generates a defect model that models a probability of the products becoming defective within a predetermined time period with respect to the monitoring information, based on the defect monitoring information and the non-defect monitoring information;
a first calculating unit that reads, from the monitoring information database, a pieces of the monitoring information corresponding to a second product type being specified and calculates a defect probability expressing a probability of products of the second product type becoming defective within the predetermined time period, based on an output value obtained by inputting the pieces of monitoring information into the defect model;
a second calculating unit that calculates a defect rate expressing a probability of the products of the second product type becoming defective within a unit time period, based on an operating quantity of the products of the second product type, a defect quantity expressing a quantity of products that have become defective among the products of the second product type, and the defect probability.

7. A defect rate calculating method comprising:
reading, from a defect database storing therein product types of defective products and pieces of identification information of the defective products that are kept in correspondence with one another, first identification information that is one of the pieces of identification information corresponding to a first product type being specified;
reading, from a monitoring information database storing therein monitoring information indicating usage statuses of products, the product types, and the pieces of identification information that are kept in correspondence with one another, defect monitoring information and non-defect monitoring information, defect monitoring information being the monitoring information corresponding to the first identification information, non-defect monitoring information being the monitoring information that corresponds to the first product type and that is other than the defect monitoring information;
generating a defect model that models a probability of the products becoming defective within a predetermined time period with respect to the monitoring information, based on the defect monitoring information and the non-defect monitoring information;
reading, from the monitoring information database, a pieces of the monitoring information corresponding to a second product type being specified and calculating a defect probability expressing a probability of products of the second product type becoming defective within the predetermined time period, based on an output value obtained by inputting the pieces of monitoring information into the defect model; and
calculating a defect rate expressing a probability of the products of the second product type becoming defective within a unit time period, based on an operating quantity of the products of the second product type, a defect quantity expressing a quantity of products that have become defective among the products of the second product type, and the defect probability.
